(19) United States
(12) Patent Application Publication
(10) Pub. No.: US 2026/0249929 A1
(43) Pub. Date: Aug. 27, 2026

(54) INSULATING ELEMENT

(71) Applicant: SIKA TECHNOLOGY AG, Baar (CH)

(72) Inventor: Brett RICHARDSON, Rochester, MI (US)

(73) Assignee: SIKA TECHNOLOGY AG, Baar (CH)

(21) Appl. No.: 18/992,368

(22) PCT Filed: Jul. 6, 2023
(86) PCT No.: PCT/EP2023/068666

§ 371 Date: Jan. 8, 2025

(30) Foreign Application Priority Data
Jul. 14, 2022 (EP) 22185035.7

(51) Int. Cl. B62D 29/00

(52) U.S. Cl. CPC B62D 29/002

(57) ABSTRACT

An insulating element for insulating a structural element in a vehicle includes a carrier which has an intermediate wall, a first side wall and a second side wall, wherein the walls of the carrier extend along a common longitudinal axis, and wherein the carrier has, in a plane perpendicular to the longitudinal axis, an H-shaped cross section in which the first side wall and the second side wall are each arranged at one end of the intermediate wall. The insulating element also includes an expandable material which is arranged both between the side walls and on both sides of the intermediate wall, and at least one fixing element which passes through both the carrier and the expandable material and is arranged substantially perpendicularly to the intermediate wall of the carrier.

The invention relates to an insulating element for insulating a structural element in a motor vehicle, and to a method for producing such insulating elements.

Components, for example bodies and/or frames of transportation and conveyance means, in particular of aquatic or terrestrial vehicles or of aircraft, frequently have structures with cavities in order to make lightweight constructions possible. However, these cavities cause a wide variety of problems. Depending on the type of the cavity, the latter has to be sealed in order to prevent the ingress of moisture and dirt, which can lead to the corrosion of the components. It is often also desirable to substantially reinforce the cavities, and thus the component, but to retain the low weight. It is often also necessary to stabilize the cavities, and thus the components, in order to reduce noises which would otherwise be transmitted along or through the cavity. Many of these cavities have an irregular shape or tight dimensions, on account of which it becomes difficult to properly seal, reinforce, and damp said cavities.

In particular in automotive construction, but also in aircraft construction and boat building, sealing elements (baffles) are therefore used in order to seal and/or acoustically insulate cavities, or reinforcing elements (reinforcers) are used in order to reinforce cavities.

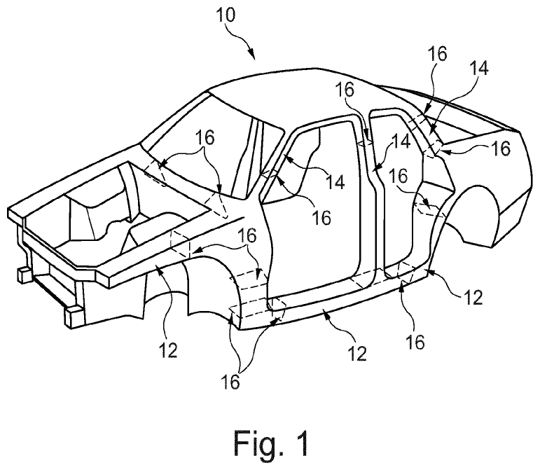

FIG. 1 schematically illustrates a body of an automobile. In this case, the vehicle body 10 has various structures with cavities, for example pillars 14 and carriers or braces 12. Such structural elements 12, 14 with cavities are usually sealed and/or reinforced, respectively, using sealing and/or reinforcing elements 16. Usually, these elements 16 are produced by a two-component injection-moulding process.

A drawback of the previously known sealing and/or reinforcing elements is that, for each vehicle body shape and for each cavity of a vehicle body, an individually adapted element has to be produced, and so new injection-moulding tools become necessary for each application. This results in high development and production costs and is disadvantageous in particular in the case of relatively small vehicle series.

For this reason, sealing elements have already been proposed which are not produced by a two-component injection-moulding process. WO 2016/176459A1, for example, discloses a method in which activatable material is extruded onto a carrier. A drawback of this solution, however, is that the activatable material is often expanded in an undesirable way or is not expanded in a targeted way, and that an insufficiently strong connection is often formed between the carrier and activatable material.

It is therefore an object of the present invention to provide an improved insulating element for insulating a structural element in a motor vehicle, which avoids the drawbacks of the prior art. The insulating element is intended to give rise in particular to economic advantages in the case of small series and to reduce the development and production outlay for the insulating elements overall, and to allow targeted and efficient expansion of the activatable material.

This object is achieved first of all by an insulating element for insulating a structural element in a vehicle, the insulating element comprising: a carrier which has an intermediate wall, a first side wall and a second side wall, wherein the walls of the carrier extend along a common longitudinal axis, and wherein the carrier has, in a plane perpendicular to the longitudinal axis, an H-shaped cross section in which the first side wall and the second side wall are each arranged at one end of the intermediate wall; an expandable material which is arranged both between the side walls and on both sides of the intermediate wall; and at least one fixing element which passes through both the carrier and the expandable material and is arranged substantially perpendicularly to the intermediate wall of the carrier.

A core concept of the present invention is in particular that, as a result of the shaping of the carrier, the expandable material is connected better to the carrier in that the side walls effectively prevent the expandable material from slipping to the side during its expansion. Moreover, as a result of this shaping, an expansion direction is also defined more precisely in that the side walls guide the expandable material in a desired direction during its expansion.

A further advantage that arises from the presently proposed shaping of the carrier is that the side walls mechanically protect the expandable material. This is significant in particular during transport, storage, or installation of the insulating elements.

In the context of this invention, the term “insulating element” or “insulation” or “insulated” covers elements or structures or method steps for partitioning and/or closing off and/or insulating a structural element. These various characteristics of such an insulating element can arise individually or in combination with one another.

### Insulating Element

In one exemplary embodiment, the intermediate wall has at least one perforation.

Such a configuration of the intermediate wall has the advantage that, as a result, a connection between the carrier and expandable material is further improved in that the expandable material on both sides of the intermediate wall is connected together through the perforation. This results in a mechanical interconnection between the expandable material and carrier, such that the expandable material can detach less readily from the carrier.

In an exemplary development, the intermediate wall has a plurality of perforations which are spaced apart from one another in particular at regular spacings in the direction of the longitudinal axis.

In an exemplary development, the at least one perforation is circular, oval or elliptical.

In an exemplary development, the plurality of perforations are arranged substantially centrally in the intermediate wall along the longitudinal axis.

In one exemplary embodiment, the side walls are mirror-symmetric to one another.

Such a configuration of the side walls has the advantage that, as a result, the insulating element can be installed both with the first side wall upward and with the second side wall upward, without a different expansion behaviour arising as a result. As a result, handling errors during the installation can be ruled out or reduced.

In one exemplary embodiment, the side walls have a substantially C- or U-shaped cross section, wherein an open side of this cross section is oriented in each case in the direction of the other side wall.

Such a configuration has the advantage that, as a result, the expandable material is protected from mechanical actions even in corner regions of the insulating element and that, moreover, targeted expansion perpendicularly away from the intermediate wall can be achieved.

In one exemplary embodiment, the expandable material comprises a first expandable material and a second expandable material, wherein the intermediate wall of the carrier is arranged between the first expandable material and the second expandable material.

In an exemplary development, the first expandable material and the second expandable material consist of the same chemical composition.

In an alternative development, the first expandable material and the second expandable material do not consist of the same chemical composition. In particular, the materials may differ in terms of their expansion rate.

In one exemplary embodiment, a cross section of the first expandable material perpendicular to the longitudinal axis is smaller than a cross section of the second expandable material perpendicular to the longitudinal axis.

Such a configuration has the advantage that, as a result, expansion on a side of the insulating element that faces away from the structural element (to which the insulating element is fastened by the fixing element) may be greater than on a side facing the structural element. As a result, the expandable material can be used more economically.

In one exemplary embodiment, the first expandable material and the second expandable material are connected together through the at least one perforation.

Such a configuration has the advantage that, as a result, a connection between the carrier and expandable material can be further improved.

In one exemplary embodiment, the insulating element has at least two fixing elements for fixing the insulating element to the structural element.

In one exemplary embodiment, the at least one fixing element is in the form of a barbed nail.

### Expandable Material

In principle, various materials that can be made to foam can be used as the expandable material. In this case, the material may or may not have reinforcing properties. Typically, the expandable material is made to expand thermally, by moisture or by electromagnetic radiation.

Such an expandable material typically has a chemical or a physical foaming agent. Chemical foaming agents are organic or inorganic compounds which decompose under the influence of temperature, moisture or electromagnetic radiation, wherein at least one of the decomposition products is a gas. Compounds which pass into the gaseous state of matter when the temperature is increased may be used for example as physical foaming agents. As a result, both chemical and physical foaming agents are capable of creating foam structures in polymers.

The expandable material is preferably foamed thermally, with chemical foaming agents being used. Examples of suitable chemical foaming agents are azodicarbonamides, sulfohydrazides, hydrogen carbonates or carbonates.

Suitable foaming agents are, for example, also commercially available under the trade name Expancel® from Akzo Nobel, the Netherlands, or under the trade name Celogen® from Chemtura Corp., USA.

The heat required for the foaming can be introduced by external or by internal heat sources, such as an exothermic chemical reaction. The foamable material is preferably foamable at a temperature of ≤250° C., in particular from 100° C. to 250° C., preferably from 120° C. to 240° C., preferably from 130° C. to 230° C.

Suitable expandable materials are, for example, one-component epoxy resin systems which do not flow at room temperature and in particular have increased impact resistance and contain thixotropic agents such as aerosils or nanoclays. For example, epoxy resin systems of this type include 20 to 50% by weight of a liquid epoxy resin, 0 to 30% by weight of a solid epoxy resin, 5 to 30% by weight of impact modifiers, 1 to 5% by weight of physical or chemical foaming agents, 10 to 40% by weight of fillers, 1 to 10% by weight of thixotropic agents and 2 to 10% by weight of heat-activatable catalysts. Suitable impact modifiers are reactive liquid rubbers based on nitrile rubber or derivatives of polyether polyol polyurethanes, core-shell polymers and similar systems known to a person skilled in the art.

Likewise suitable expandable materials are one-component polyurethane compositions containing foaming agents and based on crystalline polyesters which comprise OH groups and have been mixed with further polyols, preferably polyether polyols, and polyisocyanates with blocked isocyanate groups. The melting point of the crystalline polyester should be ≥50° C. The isocyanate groups of the polyisocyanate can be blocked for example by nucleophiles such as caprolactam, phenols or benzoxalones. Also suitable are blocked polyisocyanates as are used, for example, in powder-coating technology and are commercially available, for example, under the trade names Vestagon® BF 1350 and Vestagon® BF 1540 from Degussa GmbH, Germany. Suitable isocyanates are also so-called encapsulated or surface-deactivated polyisocyanates, which are known to a person skilled in the art and are described, for example, in EP 0 204 970.

Also suitable as expandable materials are two-component epoxy/polyurethane compositions which contain foaming agents, as are described, for example, in WO 2005/080524A1 .

Also suitable as expandable materials are ethylene-vinyl acetate compositions containing foaming agents.

Expandable materials that are also suitable are marketed by Sika Corp., USA, for example under the trade name SikaBaffle® 240, SikaBaffle® 250 or SikaBaffle® 255, and are described in patents U.S. Pat. No. 5,266,133 and U.S. Pat. No. 5,373,027. Such expandable materials are particularly preferred for the present invention.

Preferred expandable materials having reinforcing properties are, for example, those which are marketed under the trade name SikaReinforcer® 941 by Sika Corp., USA. These are described in U.S. Pat. No. 6,387,470.

In one exemplary embodiment, the expandable material has an expansion rate from 800% to 5000%, preferably from 1000% to 4000%, particularly preferably from 1500% to 3000%. Expandable materials having such expansion rates afford the advantage that, as a result, reliable sealing and/or insulation of the structural element with respect to liquids and sound can be achieved.

In one exemplary embodiment, the expandable material is in the form of a temperature-stimulated material.

This has the advantage that, as a result, the furnace for baking the dip coating liquid can be used to expand the expandable material and as a result to insulate the cavity. Consequently, an additional work step is not necessary.

### Carrier

The carrier may consist of any desired materials. Preferred materials are plastics, in particular polyurethanes, polyamides, polyesters and polyolefins, preferably polymers which can withstand high temperatures such as poly(phenylene ethers), polysulfones or polyether sulfones, which in particular are also foamed; metals, in particular aluminium and steel; or grown organic materials, in particular wood materials or other (densified) fibrous materials, or glass-type or ceramic materials; especially also foamed materials of this type; or any desired combinations of these materials. Polyamide, in particular polyamide 6, polyamide 6.6, polyamide 11, polyamide 12, or a mixture thereof, is particularly preferably used.

The carrier can be produced using various methods. In a first embodiment variant, the carrier is produced by an injection-moulding process. In a second embodiment variant, the carrier is produced by an extrusion process. In a third embodiment variant, the carrier is produced by an additive manufacturing process.

### Production Method

The object set at the beginning is also achieved by a method for producing an insulating element for insulating a structural element in a motor vehicle, the method comprising the steps of: providing a carrier which has an intermediate wall, a first side wall and a second side wall, wherein the walls of the carrier extend along a common longitudinal axis, and wherein the carrier has, in a plane perpendicular to the longitudinal axis, an H-shaped cross section in which the first side wall and the second side wall are each arranged at one end of the intermediate wall; extruding a first expandable material onto a first side of the intermediate wall of the carrier; and extruding a second expandable material onto a second side of the intermediate wall of the carrier.

In one exemplary embodiment, the extrusion of the first expandable material and the extrusion of the second expandable material take place simultaneously in a co-extrusion process.

Such a procedure has the advantage that, as a result, the expandable material can be arranged on the carried in one operation.

In one exemplary embodiment, the carrier is formed by extrusion.

Such a process has the advantage that, as a result, the carrier and expandable material are both produced by extrusion, and so the entire insulating element is able to be produced in an efficient process and on one production line.

In one exemplary embodiment, after the carrier has been formed, at least one perforation is punched into the intermediate wall of the carrier.

Such a process has the advantage that, as a result, a connection of the expandable material through the intermediate wall is allowed, with the result of improving a connection between the carrier and expandable material.

In one exemplary embodiment, the fixing element is driven manually through the expandable material and through the intermediate wall of the carrier.

In an alternative embodiment, the fixing element is driven through the expandable material and through the intermediate wall of the carrier by a machine.

In one exemplary embodiment, the fixing element is guided through a perforation in the intermediate wall of the carrier.

Details and advantages of the invention will be described in the following text on the basis of exemplary embodiments and with reference to schematic drawings, in which:

FIG. 1 shows an exemplary illustration of a vehicle body;

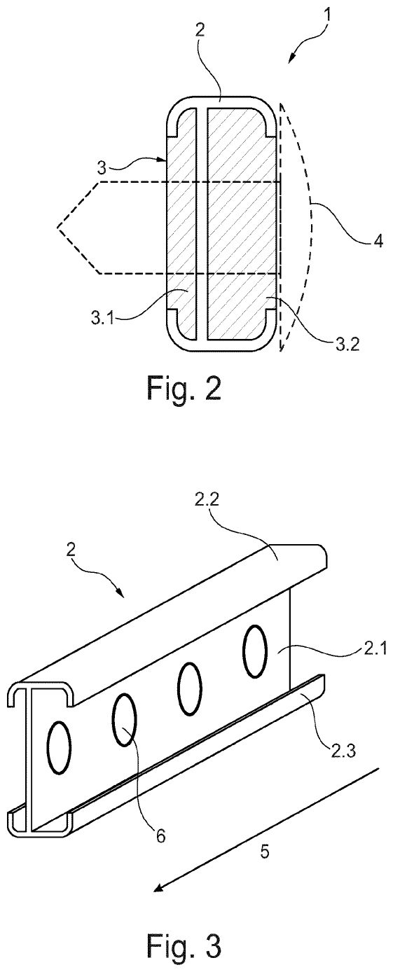

FIG. 2 shows a schematic illustration of an exemplary insulating element; and

FIG. 3 shows a schematic illustration of an exemplary carrier.

FIG. 2 schematically shows an example of an insulating element 1 in a cross-sectional illustration. The insulating element 1 has a carrier 2, expandable material 3, and a fixing element 4. The expandable material 3 comprises a first expandable material 3.1 and a second expandable material 3.2, which are arranged on either side of an intermediate wall of the carrier 2. The fixing element 4 has been driven both through the carrier 2 and through the expandable material 3. In an installed state (not illustrated), the fixing element 4 has additionally been introduced through an opening, provided for this purpose, in a structural element of the vehicle body.

FIG. 3 schematically illustrates an example of a carrier 2. The carrier 2 comprises an intermediate wall 2.1, a first side wall 2.2 and a second side wall 2.3. The side walls 2.2, 2.3 have a C-or U-shaped cross section and are mirror-symmetric to one another. The intermediate wall 2.1 has a plurality of circular perforations 6. The walls 2.1, 2.2, 2.3 of the carrier 2 extend along a longitudinal axis 5. In this case, these walls 2.1, 2.2, 2.3 form an H-shaped cross section in a cross section that is taken perpendicularly to the longitudinal axis 5.

### List of reference signs

1 Insulating element
2 Carrier
2.1 Intermediate wall
2.2 First side wall
2.3 Second side wall
3 Expandable material
3.1 First expandable material
3.2 Second expandable material
4 Fixing element
5 Longitudinal axis
6 Perforation
10 Vehicle body
12 Structural element
14 Structural element
16 Sealing or reinforcing element

1. Insulating element for insulating a structural element in a motor vehicle, the insulating element comprising:
a carrier which has an intermediate wall, a first side wall and a second side wall, wherein the walls of the carrier extend along a common longitudinal axis, and wherein the carrier has, in a plane perpendicular to the longitudinal axis, an H-shaped cross section in which the first side wall and the second side wall are each arranged at one end of the intermediate wall;
an expandable material which is arranged both between the side walls and on both sides of the intermediate wall; and
at least one fixing element which passes through both the carrier and the expandable material and is arranged substantially perpendicularly to the intermediate wall of the carrier.

2. Insulating element according to claim 1, wherein the intermediate wall has at least one perforation.

3. Insulating element according to claim 2, wherein the intermediate wall has a plurality of perforations which are spaced apart from one another at regular spacings in the direction of the longitudinal axis.

4. Insulating element according to claim 2, wherein the at least one perforation is circular, oval or elliptical.

5. Insulating element according to claim 1, wherein the side walls are mirror-symmetric to one another.

6. Insulating element according to claim 1, wherein the side walls have a substantially C- or U-shaped cross section, wherein an open side of this cross section is oriented in each case in the direction of the other side wall.

7. Insulating element according to claim 1, wherein the expandable material comprises a first expandable material and a second expandable material, wherein the intermediate wall of the carrier is arranged between the first expandable material and the second expandable material.

8. Insulating element according to claim 1, wherein a cross section of the first expandable material perpendicular to the longitudinal axis is smaller than a cross section of the second expandable material perpendicular to the longitudinal axis.

9. Insulating element according to claim 2, wherein the first expandable material and the second expandable material are connected together through the at least one perforation.

10. Insulating element according to claim 1, wherein the insulating element has at least two fixing elements for fixing the insulating element to the structural element, and/or wherein the at least one fixing element is in the form of a barbed nail.

11. Method for producing an insulating element for insulating a structural element in a motor vehicle, the method comprising the steps of:
providing a carrier which has an intermediate wall, a first side wall and a second side wall, wherein the walls of the carrier extend along a common longitudinal axis, and wherein the carrier has, in a plane perpendicular to the longitudinal axis, an H-shaped cross section in which the first side wall and the second side wall are each arranged at one end of the intermediate wall;
extruding a first expandable material onto a first side of the intermediate wall of the carrier; and
extruding a second expandable material onto a second side of the intermediate wall of the carrier.

12. Method according to claim 11, wherein the extrusion of the first expandable material and the extrusion of the second expandable material take place simultaneously in a co-extrusion process.

13. Method according to claim 11, wherein the carrier is formed by extrusion, and/or wherein, after the carrier has been formed, at least one perforation is punched into the intermediate wall of the carrier.
